(19) United States
(12) Patent Application Publication
(10) Pub. No.: US 2026/0154958 A1
(43) Pub. Date: Jun. 4, 2026

(54) IMAGE PROCESSING SYSTEM AND NON-TRANSITORY COMPUTER-READABLE RECORDING MEDIUM FOR RECORDING IMAGE PROCESSING PROGRAM

(71) Applicant: AWL, INC., Tokyo (JP)

(72) Inventors: Hiroshi FUJIMURA, Tokyo (JP); Naman MEHTA, Tokyo (JP); Tian YU, Tokyo (JP); Fadoua GHOURABI, Tokyo (JP); Joo Ann WOO, Tokyo (JP); Harsh SILOIYA, Tokyo (JP); Zheng LIU, Tokyo (JP); Wasu WASUSATEIN, Tokyo (JP); Kittinun AUKKAPINYO, Tokyo (JP); Intisar MD CHOWDHURY, Tokyo (JP); Kriti AGARWAL, Tokyo (JP); Yoshinao SHIBAGAKI, Tokyo (JP); Baskara ., Tokyo (JP)

(73) Assignee: AWL, INC., Tokyo (JP)

(21) Appl. No.: 19/395,811

(22) Filed: Nov. 20, 2025

(30) Foreign Application Priority Data
Nov. 29, 2024 (JP) 2024-209107

(51) Int. Cl. G06V 10/96; G06F 16/535; G06F 40/40; G06V 10/94; G06V 20/50

(52) U.S. Cl. CPC G06V 10/96; G06F 16/535; G06F 40/40; G06V 10/95; G06V 20/50

(57) ABSTRACT

An image processing system has a process selection circuitry configured to select respective processes corresponding to each of plural tasks that constitute image processing requested by a user, and a process execution circuitry configured to connect and perform the respective processes selected by the process selection circuitry.

### CROSS-REFERENCE TO RELATED APPLICATION

This application is based on and claims the benefit of priority of the prior Japanese Patent Application No. 2024-209107, filed on Nov. 29, 2024, the entire contents of which are incorporated herein by reference.

### BACKGROUND OF THE INVENTION

### 1. Field of the Invention

The present invention relates to an image processing system, and a non-transitory computer-readable recording medium for recording an image processing program.

### 2. Description of the Related Art

Conventionally, the technique of detecting an object such as a person appearing in an image captured by a camera and recognizing what the detected object is (recognizing attributes such as a color and a type of the detected object) is widely used. Although a technique of pattern recognition is also used for the above-described object detection and object recognition, recently a technique of a pre-trained model using a neural network, which outputs a detection result or a recognition result of an object appearing in target image data when the image data is input, has been evolving. The pre-trained model is learned for each type of object, or learned for each image capturing environment so that object detection or object recognition can be performed more accurately according to the type of object appearing in an image. In other words, the learning of pre-trained model is optimized by subdivision.

On the other hand, there is provided a foundation model that has been learned using a data set having an enormous amount of data, can handle objects in any field, and can handle also input and output of languages. The foundation model can perform various tasks such as image generation and natural language conversation on data in a wide range of fields. Inference can be performed in a wide range of fields regardless of an analysis target by using a foundation model that has been widely learned using extensive data so as to be able to respond to requests in such various fields.

If a pre-trained model is learned for each type of target object, or learned for each image capturing environment, the pre-trained model fits a specific purpose or environment, and thus lacks versatility. On the other hand, the foundation model has high versatility, because it is learned using a data set having an enormous amount of data. However, the foundation model may not be able to obtain outputs with the user's desired accuracy for a specific purpose or environment.

Japanese Patent No. 6178942 proposes a method of selecting a model by a user's operation on the assumption that character recognition can be performed more accurately by using an individual pre-trained learning model learned according to features than by using a common pre-trained learning model. The inventor of the above-described patent proposes, particularly for character recognition, selecting a model according to a handwriting habit different for each user.

Many pre-trained learning models dedicated to data in various fields are also provided. However, even if a user can manually select a pre-trained learning model for each data in various fields, a user is requested to have high skill and knowledge in order to select an appropriate model.

### BRIEF SUMMARY OF THE INVENTION

An object of the present invention is to solve the problems described above, and to provide an image processing system, and a non-transitory computer-readable recording medium for recording an image processing program that make it possible to appropriately perform image processing requested by a user.

According to a first aspect of the present invention, this object is achieved by an image processing system comprising: a process selection circuitry configured to select respective processes corresponding to each of plural tasks that constitute image processing requested by a user; and a process execution circuitry configured to connect and perform the respective processes selected by the process selection circuitry.

This image processing system is configured to select respective processes corresponding to each of plural tasks that constitute image processing requested by a user and then connect and perform the respective processes. Thus, for example, it is possible to connect and perform the respective processes using pre-trained learning models that are dedicated to a certain field, a certain configuration, or the like and learned with high accuracy. This makes it possible to obtain a result of image processing with high accuracy as compared with the case of using the foundation model adapting to a wide range of fields.

According to a second aspect of the present invention, the above object is achieved by an image processing system comprising: an input circuitry configured to allow a user to input a query corresponding to desired image processing; and a breakdown circuitry configured to break a task included in the query input by the input circuitry down into a plurality of known tasks.

According to a third aspect of the present invention, the above object is achieved by an image processing system comprising: an input circuitry configured to allow a user to input a query corresponding to desired image processing; a breakdown circuitry configured to break a task included in the query input by the input circuitry down into a plurality of known tasks; a process selection circuitry configured to select respective processes corresponding to each of the plurality of known tasks broken down by the breakdown circuitry; and a process execution circuitry configured to connect and perform the respective processes selected by the process selection circuitry.

According to a fourth aspect of the present invention, the above object is achieved by a non-transitory computer-readable recording medium for recording an image processing program to cause a computer to perform a process including the steps of: selecting respective processes corresponding to each of plural tasks that constitute image processing requested by a user; and connecting and performing the respective processes.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that the drawings are shown for the purpose of illustrating the technical concepts of the present invention or embodiments thereof, wherein:

FIG. 1 is a schematic block diagram showing an outline of an image processing system according to a first embodiment of the present invention;

FIG. 2 is a schematic block diagram showing a hardware configuration of an outline of an image processing device in FIG. 1;

FIG. 3 is a schematic block diagram showing a hardware configuration of an outline of a server in FIG. 1;

FIG. 4 is a schematic block diagram showing a hardware configuration of an outline of a client in FIG. 1;

FIG. 5 is a flow chart illustrating an example of a process selection processing procedure in the image processing system according to the first embodiment;

FIG. 6 is a diagram illustrating an example of a processing in which processes are selected in the image processing device according to the first embodiment;

FIG. 7 is a schematic functional block diagram of the image processing system according to the first embodiment;

FIG. 8 is a schematic block diagram showing a hardware configuration of a server in the second embodiment;

FIG. 9 is a flow chart illustrating an example of a process selection processing procedure in the image processing system according to the second embodiment;

FIG. 10 is a diagram illustrating an example of a processing in which processes are selected in the image processing device according to the second embodiment;

FIG. 11 is a diagram illustrating another example of a processing in which processes are selected in the image processing device according to the second embodiment;

FIG. 12 is a flow chart illustrating an example of a process selection processing procedure in the image processing system according to the third embodiment;

FIG. 13 is a flow chart illustrating an example of a process selection processing procedure in the image processing system according to the third embodiment;

FIG. 14 is a diagram illustrating an example of a processing in which processes are selected in the image processing device in the third embodiment;

FIG. 15 is a schematic functional block diagram of the image processing system according to the third embodiment.

### DETAILED DESCRIPTION OF THE INVENTION

Hereinafter, an image processing system, and a non-transitory computer-readable recording medium for recording an image processing program according to embodiments of the present invention will be described with reference to the drawings.

### First Embodiment

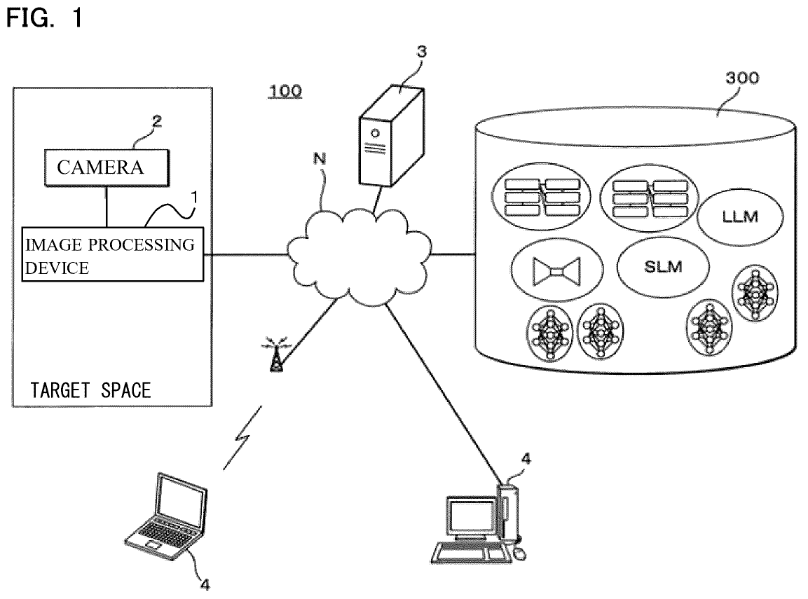

FIG. 1 is a schematic diagram showing an outline of an image processing system 100 according to a first embodiment. The image processing system 100 includes a camera 2, an image processing device 1 connected to the camera 2, a server 3 capable of connection to the image processing device 1, and a client 4 capable of connection to the server 3.

The image processing system 100 according to the first embodiment is a system that selects processes to be performed by the image processing device 1 on an image captured by the camera 2 installed in a target space and causes the image processing device 1 to perform the processes. The processes may be performed using a pre-trained learning model provided from an external service outside the image processing system 100, or may be performed using a learning model designed and trained by the image processing system 100.

The image processing system 100 receives a request from a user via the client 4, and selects respective processes of respective tasks to be performed in accordance with the received request. The image processing system 100 may receive a user's request for what to do using the camera 2 as a natural sentence and determine which processes to select using a language model, or may receive a user's request by causing the user to directly select processes.

In the image processing system 100, a user interface connected to the image processing device 1 may receive a request from a user, and the image processing device 1 may perform a function of selecting respective processes corresponding to each of plural tasks according to the user's request. In the image processing system 100, the client 4 may receive a request from a user and transmit the request to the image processing device 1 via the network N, and the image processing device 1 may perform a function of selecting respective processes corresponding to each of plural tasks according to the user's request. In the image processing system 100, the client 4 may receive a request from a user and transmit the request to the server 3 via the network N, and the server 3 may perform a function of selecting respective processes corresponding to each of plural tasks according to the user's request. In the following description, it is assumed that the server 3 performs the process selection function.

A configuration for realizing such an image processing system 100 will be described in more detail below. In FIG. 1, the camera 2 uses an image element for visible light or near-infrared light and outputs image data. The camera 2 outputs image data in time series at a rate of several FPS (frames per second) to several tens of FPS. The camera 2 sequentially transmits image data to the image processing device 1 via a directly connected communication line or a local network.

The image processing device 1 performs respective processes selected by the image processing system 100 on image data acquired from the camera 2. The image processing device 1 outputs an execution result obtained by performing (executing) the selected processes to the client 4. The image processing device 1 may store the execution result in the device itself so that the client 4 can read the execution result, or may transmit the execution result to the client 4 via the network N. The image processing device 1 may transmit the execution result of the processes to the server 3 via the network N, store the execution result in the server 3 so that the client 4 can read the execution result from the server 3.

The server 3 holds pre-trained learning models to be used in respective processes to be performed by the image processing device 1 in the database 300. The database 300 also includes pre-trained learning models provided from an external service outside the image processing system 100. The server 3 reads respective pre-trained learning models corresponding to respective processes selected for the image processing device 1 from the database 300 and deploys the pre-trained learning models to the image processing device 1.

The database 300 holds a detection model in which whether or not a specific person or object appears in an input image is learned according to a feature of a target (person or object), such as a model for detecting whether or not a person appears in an input image, and a model for detecting whether or not a vehicle appears in an input image so that the detection model can be provided. The database 300 holds also a recognition model for recognizing an attribute of a detected person or object so that the recognition model can be provided. For example, the database 300 holds a model for recognizing an age group of a person as an attribute. Further, the database 300 holds models for recognizing attributes such as a type and a product number of a detected object. The database 300 holds object recognition models for recognizing clothes, ornaments, and the like worn by the detected person. The database 300 may hold a model for recognizing a color, a pattern, or the like of a detected object.

Each of the person detection model, the object detection model, and the attribute recognition model is modularized as a detector or a recognizer, and may be provided so that one or more detectors or recognizers can be connected in any order.

The database 300 holds a language model pre-trained to output, as a natural sentence, a group of words having a high appearance probability as a response to an input query. The database 300 holds, as language models, a large language model (LLM) that can be used in a device with abundant computing resources, a small language model (SLM) that can be used in a device with few computing resources, and a medium-scale language model that can be used in a device with medium computing resources. The database 300 holds a VLM (Vision Language Model) for receiving a query together with image data and a multimodal language model for receiving a query together with voice data so as to be able to provide them.

The database 300 holds a plurality of types of configuration data including setting information such as a size of a detection target region or a recognition target region in an image for a model for detecting a person or an object from an image or a model for recognizing an attribute or the like of a detected person or object. The database 300 holds configuration data so that the configuration data can be provided according to the installation environment, the image size, or the resolution of the camera 2.

In the image processing system 100 according to the first embodiment, the server 3 selects the learning model and the configuration data held in the database 300 in response to a request from the user and causes the image processing device 1 to perform the selected learning model according to the configuration data.

The server 3 may store the data transmitted from the image processing device 1 in association with the data for identifying the target space. The server 3 may aggregate the transmitted data and create data that can be referred to from the client 4.

Hereinafter, detailed configurations of the image processing device 1 and the server 3 for realizing the image processing system 100 and details of processing will be described.

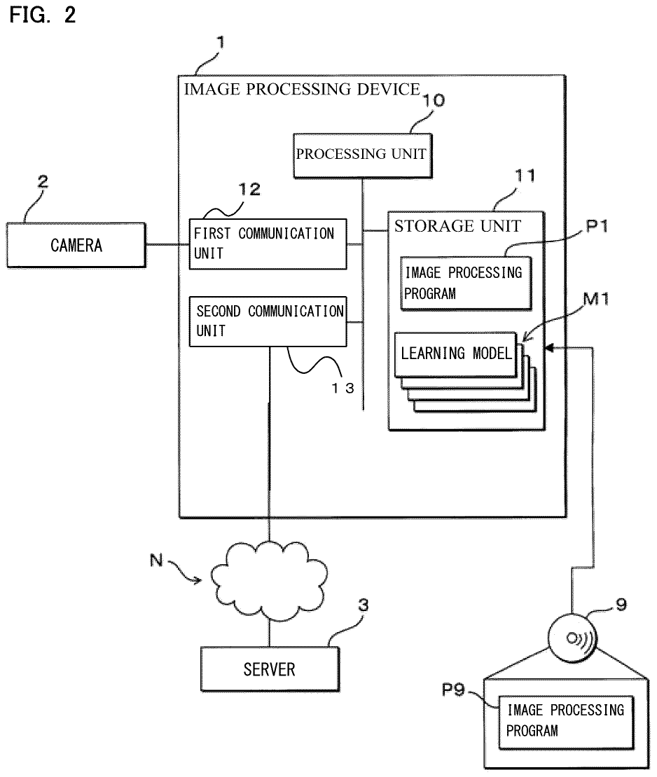

FIG. 2 is a block diagram illustrating a configuration of the image processing device 1. The image processing device 1 is a so-called edge computer. In the following description, the image processing device 1 will be described as one computer. However, the image processing device 1 may be configured such that a plurality of computers share processing for respective processes among the computers. The image processing device 1 comprises a processing unit 10, a storage unit 11, a first communication unit 12, and a second communication unit 13. Not only the storage unit 11, but also a computer-readable storage medium 9 shown in FIG. 2 corresponds to the “non-transitory computer-readable recording medium” in the claims.

The processing unit 10 includes one or more processors such as a central processing unit (CPU), a micro-processing unit (MPU), a graphics processing unit (GPU), and a neural processing unit (NPU). The processing unit 10 includes a memory that is a temporary storage medium such as a static random access memory (SRAM) or a dynamic random access memory (DRAM). The processing unit 10 includes a timer and can acquire time information at each time point from data from the timer. The processing unit 10 may be configured as one piece of hardware (SoC: system on a chip) in which a processor, a memory, the storage unit 11, the first communication unit 12, and the second communication unit 13 are integrated.

The processing unit 10 causes the processor to perform image processing based on the image processing program P1 stored in the storage unit 11 and the pre-trained learning models which the server 3 selected from the database 300 and deployed to the image processing device 1.

The storage unit 11 is a relatively large-capacity non-transitory storage medium such as a hard disk or a flash memory. A part of the storage unit 11 may be removable.

The storage unit 11 stores a program (program product) necessary for the processing unit 10 to perform processing, a processing result of the processing unit 10, and setting data for reference. The setting data includes identification data of the image processing device 1 itself. The program product includes an operating system (OS) program, an image processing program P1 operating on the OS, and a learning model group M1. The learning model group M1 will be described in detail later.

The image processing program P1 stored in the storage unit 11 may be an image processing program P9 stored in a computer-readable storage medium 9 and be read from the computer-readable storage medium 9 to be stored in the storage unit 11 by the processing unit 10, or may be stored in the storage unit 11 prior to shipment of the image processing device 1. The image processing program P1 stored in the storage unit 11 may be downloaded by the processing unit 10 from the server 3 or another download server via the second communication unit 13 and stored into the storage unit 11.

The image processing program P1 stored in the storage unit 11 is configured to cause a computer to perform respective processes corresponding to each of plural tasks. In the image processing system 100, it is possible to select processes to be performed using the image processing program P1. The image processing program P1 may be configured by acquiring program modules for performing processes corresponding to a plurality of tasks from the server 3 and combining the modules.

At least a part of the learning model group M1 stored in the storage unit 11 is selected from the database 300. The setting data to be stored in the storage unit 11 may include configuration data selected from the database 300. The learning model group M1 and the configuration data selected from the database 300 and received by the processing unit 10 via the second communication unit 13 may be stored into a temporary storage medium (RAM) in the processing unit 10 without being stored into the storage unit 11.

The first communication unit 12 is a communication device that realizes communication via a local network in a space where the camera 2 is installed. The first communication unit 12 may be a local area network (LAN) card or a controller area network (CAN) communication device. The first communication unit 12 may be a communication device compatible with a wireless network such as WiFi or Bluetooth. The first communication unit 12 may include a plurality of communication devices corresponding to various types of cameras 2. The first communication unit 12 may include an interface such as a universal serial bus (USB) to be connected to the camera 2. The first communication unit 12 can be replaced with an interface to be connected to the camera 2 via a coaxial cable or another serial bus. The processing unit 10 acquires image data from the camera 2 via the local network by the first communication unit 12. The first communication unit 12 may be the same device as the second communication unit 13.

The second communication unit 13 is a communication device for communicating via the network N with a communication device outside the space where the camera 2 is installed. The second communication unit 13 may be a wired LAN network card, a communication device that realizes carrier communication via a carrier network, or a communication device compatible with a wireless network such as WiFi or Bluetooth. The second communication unit 13 is preferably compatible with encrypted communication such as SSL with the server 3. The second communication unit 13 may be an interface for communicating with the server 3 via a dedicated line.

The image processing device 1 may directly receive a user operation via a user interface connected via the second communication unit 13.

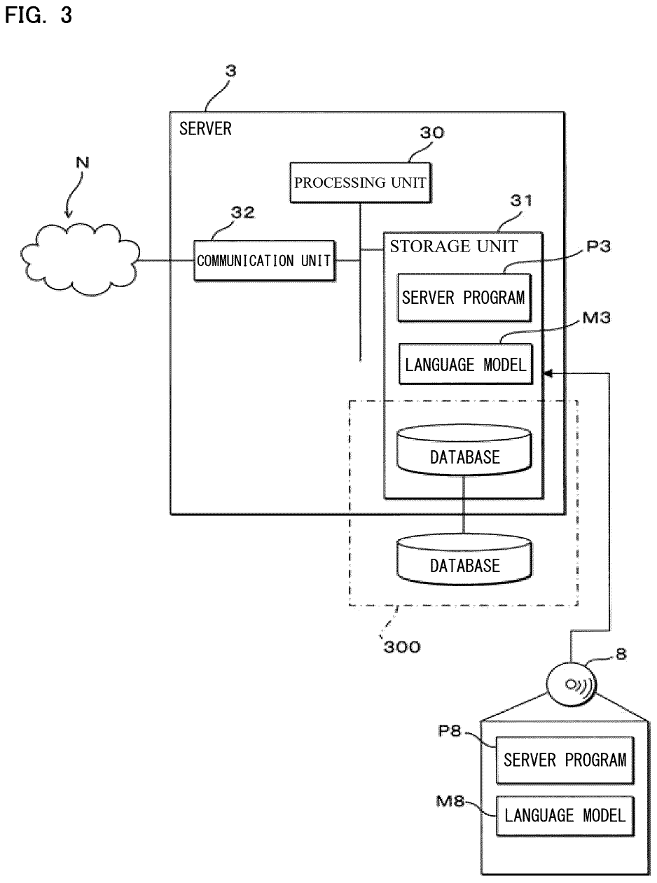

FIG. 3 is a block diagram illustrating a configuration of the server 3. The server 3 may be configured by one server computer, or may be composed of a plurality of server computers and be configured to perform distributed processing across the plurality of server computers. The server 3 includes a processing unit 30, a storage unit 31, and a communication unit 32.

The processing unit 30 includes one or more processors such as CPUs, MPUs, GPUs, and NPUs. The processing unit 30 includes a memory that is a temporary storage medium such as an SRAM or a DRAM.

The storage unit 31 is a relatively large-capacity non-transitory storage medium such as a hard disk or a flash memory. The storage unit 31 stores a program (program product) and setting data necessary for the processing unit 30 to perform processing.

The program product stored in the storage unit 31 includes a server program P3. The server program P3 includes a module that functions as a data server that reads the learning model group M1 stored in the database 300 and transmits the learning model group M1 to the image processing device 1. The server program P3 includes a module that functions as a Web server, and can output a result of processing performed by the server 3 to the client 4 via a Web page.

The program product stored in the storage unit 31 includes a language model (LM) M3. The language model M3 outputs a response corresponding to the input natural sentence (query). The language model M3 is used to provide an output for selecting a process in response to a request from a user, separately from the language model stored in the database 300. The language model M3 may be a model that is partially or entirely provided by an external language model service via the network N. The processing using the language model M3 will be described in detail later.

The server program P3 and the language model M3 may be obtained in a way that the processing unit 30 reads the server program P8 and the language model M8 stored in the computer-readable storage medium 8 to store the server program P8 and the language model M8 into the storage unit 31, or may be downloaded from another download server via the communication unit 32 and stored into the storage unit 31 by the processing unit 30.

The setting data stored in the storage unit 31 includes data for identifying the image processing device 1 as a process selection target via the server 3. In addition, the setting data includes data showing a correspondence relationship between data or a name for identifying a space in which the image processing device 1 is installed and identification data of the camera 2 from which the image processing device 1 can acquire an image, in association with data for identifying the image processing device 1. The storage unit 31 may store identification data of the image processing device 1 or the space for which the user's request is permitted as a white list in association with the user's account data. Accordingly, when the user designates the name of a space and requests what image processing should be performed on an image captured by the camera 2 installed in the space, the server 3 can specify the target image processing device 1.

The database 300 may be constructed in the storage unit 31 or may be constructed in an external storage device. A part of the database 300 may include the external model providing service being used on the Web connected via the network N as described above.

The communication unit 32 is a communication device that realizes communication connection with the client 4 and the image processing device 1 via the network N.

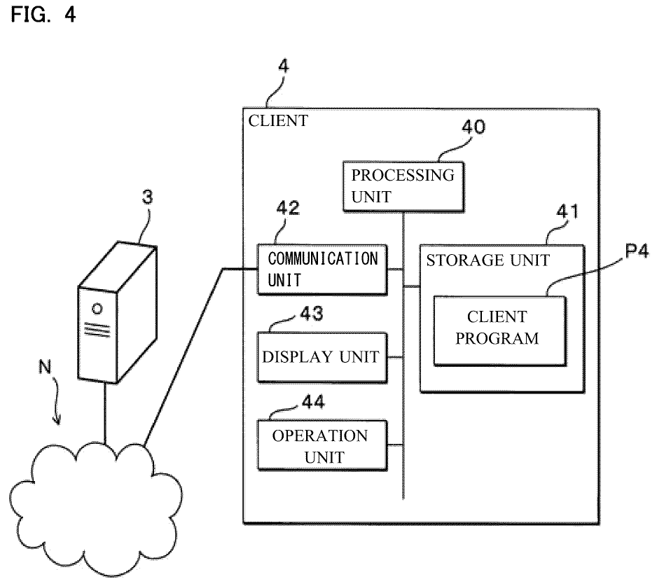

FIG. 4 is a block diagram showing the hardware configuration of the client 4. The client 4 is a personal computer, a smartphone, or a tablet terminal. The client 4 may be used by a manager of a space in which the camera 2 is installed, or may be used by an operator of a management company of the server 3.

The client 4 includes a processing unit 40, a storage unit 41, a communication unit 42, a display unit 43, and an operation unit 44. The processing unit 40 includes one or more processors such as a CPU, an MPU, a GPU, and an NPU. The processing unit 40 includes a memory that is a temporary storage medium such as an SRAM or a DRAM.

The storage unit 41 is a memory of a non-transitory storage medium such as a hard disk or a flash memory. The storage unit 41 stores a module to use the function of the data server provided from the server 3 and a client program P4 to function as the Web client. The client program P4 is, for example, a Web browser program. The client program P4 may be a program that causes the processing unit 40 to perform a process of displaying data provided from the server 3 on a screen.

The communication unit 42 is a communication device that realizes communication connection with the server 3 via the network N. The communication unit 42 may be a communication device that realizes communication connection with the server 3 via a dedicated line. The communication unit 42 may be a communication device that realizes direct communication connection with the second communication unit 13 of the image processing device 1 via a wireless communication medium, a USB cable, or the like.

As the display unit 43, a display such as a liquid crystal display or an organic electro luminescence (EL) display is used. The display unit 43 displays a Web page including characters and images by processing of the processing unit 40 according to the client program P4. A display with a built-in touch panel may be used as the display unit 43.

The operation unit 44 is a user interface such as a keyboard or a pointing device that receives an operation from a user or an operator. The operation unit 44 may be a touch panel built-in the display of the display unit 43, or may be a physical button. The operation unit 44 may be a voice input unit and receive an operation by voice using a voice recognition function. The operation unit 44 can notify the processing unit 40 of operation by a user or an operator.

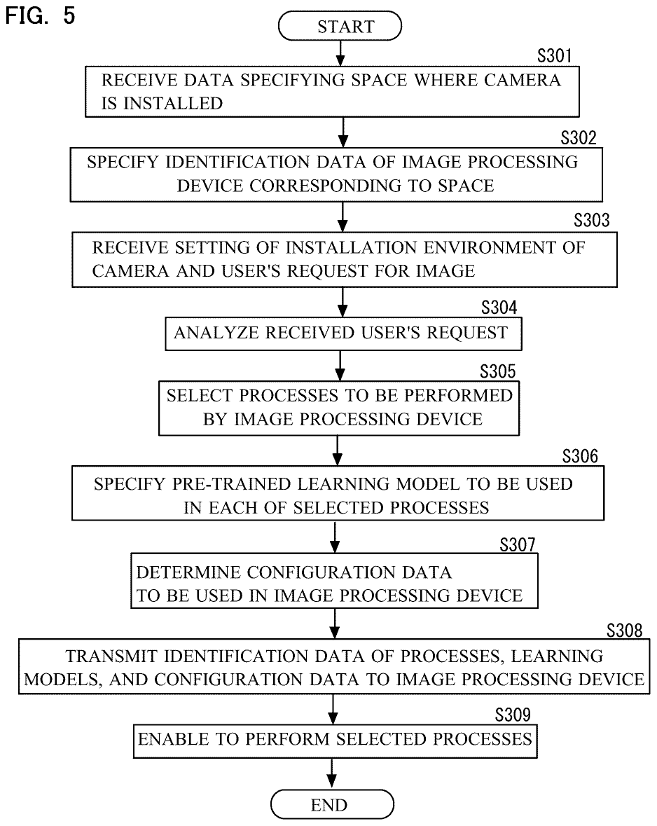

Processing, in which processes are selected for the image processing device 1 and the selected processes become executable in the image processing system 100 configured as described above, will be described. FIG. 5 is a flowchart illustrating an example of a process selection processing procedure in the image processing system 100 according to the first embodiment. When the user accesses the server 3 using the client 4 and accesses a Web page for setting the image processing device 1, the server 3 starts the following processing.

The processing unit 30 of the server 3 receives, as a request from the user, data specifying a space where the camera 2 whose images are processed is installed (step S301). In the step S301, the processing unit 30 receives one or more among account data of a user, identification data or a name of a space, and identification data of the camera 2. In the step S301, the processing unit 30 may receive a selection from the list of the identification data of the image processing devices 1 permitted to be accessed with the account data used when the client 4 accesses the server 3, or the identification data or the names of the spaces corresponding to the identification data of the permitted image processing devices 1.

The processing unit 30 specifies the identification data of the image processing device 1 corresponding to the space specified by the received data (step S302).

The processing unit 30 receives, on the web page, the setting of the installation environment of the space where the camera 2, whose image are processed by the specified image processing device 1, is installed, and the user's request for the image captured by the camera 2 (step S303). In the step S303, the processing unit 30 receives a natural sentence input into an input field included in the web page displayed on the client 4 as a user's request. In the step S303, the processing unit 30 may receive selection of an option for a question included in the web page displayed on the client 4. For example, the processing unit 30 may receive a plurality of selections from options of tasks (a person or an object to be detected, and an attribute of a recognition target) displayed on a web page. In the step S303, the processing unit 30 receives, as the setting of the installation environment, information such as the installation environment of the camera 2 such as the indoors, the outdoors, an entrance, an exit, and a passage, the size of the imaging target of the camera 2 in the image, the fame rate of the camera 2, and the specifications of the image processing device 1.

The processing unit 30 analyzes the received user's request (step S304). In the step S304, in the first example, the processing unit 30 combines a natural sentence (query) received as a user's request and an instruction sentence instructing to output a task corresponding to the natural sentence in a predetermined format, inputs the combined sentences to the language model M3, and acquires a sentence (word group) output from the language model M3. The processing unit 30 may specify a person or an object to be detected and an attribute of a recognition target.

The processing unit 30 selects one or more processes to be performed by the image processing device 1 based on the analysis result of the step S304 (step S305). The processing unit 30 specifies a pre-trained learning model to be used in each of the selected processes from the database 300 (step S306). In the step S305 or the step S306, the processing unit 30 may select a process or specify a learning model with reference to the setting of the installation environment of the camera 2 received in the step S303. The processing unit 30 specifies that the LLM is used, for example, in a case where the processing speed and the memory are equal to or higher than a predetermined specification level from the data of the calculation resource included in the specification of the image processing device 1, and specifies that the SLM is used in the opposite case.

The processing unit 30 determines (selects) the configuration data to be used in the image processing device 1 from configuration data stored in the database 300 according to the received setting of the installation environment (step S307). In the step S307, the processing unit 30 determines the configuration data to be used in accordance with the installation environment of the camera 2 such as the indoors, the outdoors, an entrance, an exit, and a passage, the size of the imaging target of the camera 2 in the image, the fame rate of the camera 2, and the specification of the image processing device 1.

The processing unit 30 transmits the identification data of the processes selected in the step S305, the learning models specified in the step S306, and the configuration data determined in the step S307 to the image processing device 1 (step S308). The processing unit 30 enables the image processing device 1 to perform processes using the transmitted learning models and configuration data (step S309). In the step S309, the processing unit 30 of the server 3 generates an instance of the image processing program P1 configured to perform the selected processes, and transmits the generated instance to the image processing device 1. The processing unit 10 of the image processing device 1 stores this instance into the storage unit 11 as the image processing program P1. In other words, the processing unit 30 of the server 3 deploys the image processing program P1 to the image processing device 1.

Thus, the processing unit 10 of the image processing device 1 can perform the selected processes on the images acquired from the camera 2 by using the image processing program P1.

The processing procedure illustrated in FIG. 5 has been described as being performed by the server 3. Alternatively, the image processing device 1 may receive an operation from the client 4 via the network N and perform the processing procedure illustrated in FIG. 5, or the image processing device 1 may directly receive an operation from the client 4 via the second communication unit 13 and perform the processing procedure illustrated in FIG. 5 using the language model M3 provided from the server 3.

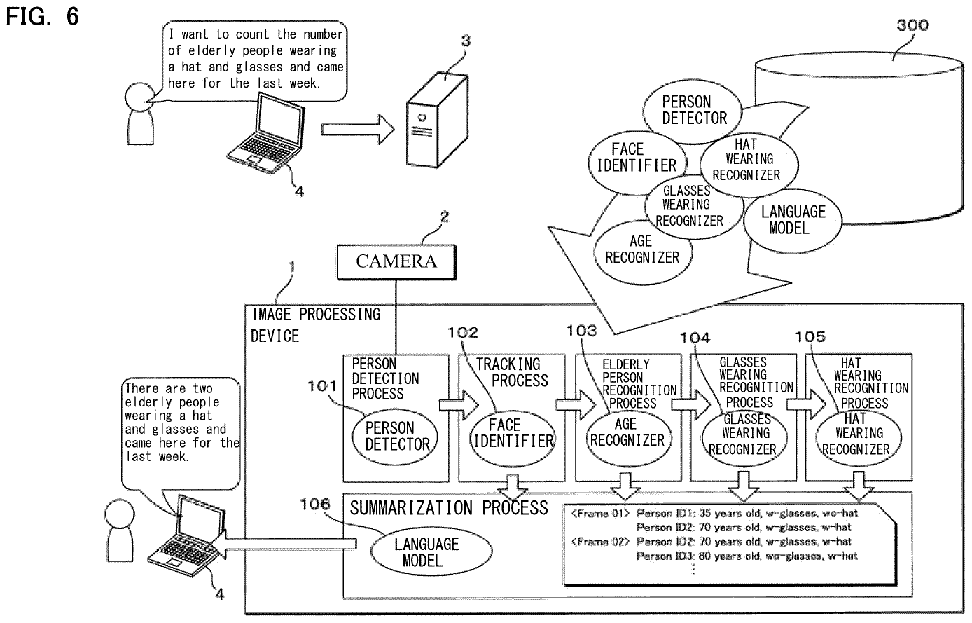

The processing procedure shown in FIG. 5 will be described with a specific example. FIG. 6 is a diagram illustrating an example of processing in which respective processes are selected in the image processing device 1 according to the first embodiment. In the example illustrated in FIG. 6, a processing in a case where the user designates data for identifying a space, in which the target camera 2 is installed, and inputs a natural sentence “I want to count the number of elderly people who wore a hat and glasses and came to this place for the last week.” in the client 4 is illustrated.

The server 3 adds, to the above-described natural sentence received as the request from the user, the instruction sentence “Please extract tasks necessary for realizing the attached request according to the following rules. Rule: <detection target>target, <detection target tracking method>unit to be tracked, <attribute to be recognized>.” and gives the combined sentences to the language model M3.

In the example of FIG. 6, the language model M3 outputs the word group “<detection target>person detection, <detection target tracking method>person ID assignment by person tracking, <attribute to be recognized>old age, wearing glasses, wearing a hat.” The above-described information of “<attribute to be recognized>old age, wearing glasses, wearing a hat” corresponds to “information of a recognition target obtained by an object recognition task included in the query” extracted by “the breakdown circuitry” in the claim. Based on the output (word group) from the language model M3, the processing unit 30 of the server 3 selects a person detection process of detecting a person from an image using a person detection model (a person detector) and a tracking process of assigning the same ID to the same person detected over a plurality of frame images from the feature amount of the detected person. For the tracking process, the processing unit 30 selects a face identification model (a face identifier) in order to identify the same person. The processing unit 30 further selects an elderly person recognition process for recognizing whether or not the detected person is elderly by using an age recognition model (an age recognizer). The processing unit 30 further selects a glasses wearing recognition process of recognizing whether or not the detected person wears glasses using a glasses recognition model (a glasses wearing recognizer) and a hat wearing recognition process of recognizing whether or not the detected person wears a hat using a hat recognition model (a hat wearing recognizer). The processing unit 30 further selects a summarization process of giving to the large-scale language model the results of the elderly person recognition process, the glasses wearing recognition process, and the hat wearing recognition process for a plurality of frame images over one week to obtain results summarized every designated period, here, every one week.

In a case where the user's request is received by receiving the selection of the option presented on the web page without using the language model M3, the processing unit 30 specifies the tasks as “person detection/person tracking/whether or not the user is elderly, whether or not the user wears glasses, and whether or not the user wears a hat.” In this case, the processing unit 30 may select a person detection process, a tracking process, an elderly person recognition process, a glasses wearing recognition process, a hat wearing recognition process, and a summarization process corresponding to each of the above-described tasks.

The processing unit 30 specifies a person detection model, a face identification model, an age recognition model, a glasses recognition model, a hat recognition model, and a large-scale language model for summarization to be used in each of the selected processes from among the learning models stored in the database 300. The processing unit 30 transmits data for identifying the selected processes or executable files corresponding to the processes, models readable from the executable files, and configuration data to the image processing device 1.

The image processing device 1 stores a person detection model (a person detector) 101, a face identification model (a face identifier) 102, an age recognition model (an age recognizer) 103, a glasses recognition model (a glasses wearing recognizer) 104, a hat recognition model (a hat wearing recognizer) 105, and a language model for summarizing 106 into the storage unit 11 so as to be usable as a learning model group M1 based on the transmitted data for identifying the processes. The processing unit 10 makes the image processing program P1 cooperate with the learning model group M1 to be used by the person detection process, the tracking process, the elderly person recognition process, the glasses wearing recognition process, the hat wearing recognition process, and the summarization process with reference to the configuration data based on the data for identifying the processes, and sets the image processing program P1 in an executable state.

Thereafter, the processing unit 10 of the image processing device 1 acquires frame images output from the camera 2 in time series, assigns identification data to the frame images, and performs the person detection process on each of the frame images. In the person detection process, the processing unit 10 provides the frame image to the person detection model 101 and obtains a detection result (coordinate data of a person region) output from the person detection model 101. The processing unit 10 improves the detection accuracy of the person detection model 101 by referring to the size of the image and the like included in the configuration data. When a person is not detected in the person detection process, the processing unit 10 performs processing on the next frame image.

When a person is detected in the person detection process, the processing unit 10 provides the frame image and the detection result to the tracking process. In the tracking process, the processing unit 10 acquires a feature amount of a face of the person detected from the input frame image using the face identification model 102, associates a person ID with the feature amount, and specifies the person ID of the detected person. Also in the tracking process, the processing unit 10 preferably refers to the configuration data.

The processing unit 10 passes the frame image, the detection result, and the person ID of the detected person to the elderly person recognition process, the glasses wearing recognition process, and the hat wearing recognition process. In each of the elderly person recognition process, the glasses wearing recognition process, and the hat wearing recognition process, the processing unit 10 outputs whether or not the person identified by the person ID is an elderly person, whether or not the person wears glasses, and whether or not the person wears a hat, using the learning model group M1. The image processing program P1 may be configured such that the processing unit 10 sequentially performs the elderly person recognition process, the glasses wearing recognition process, and the hat wearing recognition process. In this case, the processing unit 10 performs a glasses wearing recognition process of recognizing whether or not the detected person wears glasses only when the detected person is recognized as an elderly person, and performs a hat wearing recognition process of recognizing whether or not the detected person wears a hat only when the detected person is recognized as wearing glasses in the glasses wearing recognition process.

The processing unit 10 integrates results of the recognition process performed on each of the plurality of frame images, and stores, for each frame image, data indicating that a target has been detected together with identification data of the frame image and the person ID when a person detected from the frame image is an elderly person, wears glasses, and wears a hat. The processing unit 10 may also store information of the time (time information), when the frame image is captured, together with the above-described data. The processing unit 10 may store only the frame image, in which the target is detected, into the storage unit 11. Then, in the summarization process, the processing unit 10 aggregates the stored data (frame images in which targets are detected) for a designated period (here, one week), gives the aggregation result to the language model M3, and outputs the explanation of the aggregation result for one week in a natural sentence.

The processing unit 10 of the image processing device 1 may integrate the results of respective recognition processes performed on each of the plurality of frame images, and may transmit, for each frame image, identification data of the frame image to the server 3 when a person detected from the frame image is an elderly person, wears glasses, and wears a hat. In addition to the identification data of the frame image in which the target is detected, the person ID (feature amount) of the detected person and the detection time information may be transmitted to the server 3. The process of aggregation and summarization using the language model M3 may be performed by the server 3.

The user can refer to the description of the detection result and the aggregation result stored in the image processing device 1 every week using the client 4. The client 4 may directly acquire the weekly aggregation result stored in the storage unit 11 of the image processing device 1 via the second communication unit 13 of the image processing device 1 and display the result on a screen based on the client program P4, or may acquire the result via the server 3 and output the aggregation result on a web page provided by the server 3.

In the example of FIG. 6, the natural sentence “There are two elderly people who wore a hat and glasses and came to this place for the last week.” is output as the aggregation result. The server 3 may store identification data of frame images associated with person IDs of two persons, the person IDs, and time information of the frame images, and the user may refer to the frame images via the client 4.

As illustrated in FIG. 6, the image processing system 100 automatically selects processes according to the user's request only by the user inputting a request for what to do using an image captured by the target camera 2 to the image processing system 100 in a natural language, for example, on a web page or the like. Therefore, it is not necessary for the user to select a learning model prepared according to various specifications (of the image processing device 1 or the like) for data of various fields. The data on the installation environment of the camera 2 and the information on the specifications of the camera 2 and the image processing device 1 are also passed to the image processing system 100, and the image processing system 100 selects a model and a process according to the specifications. Thus, it is not necessary to use an unnecessarily high-accuracy model that does not match the specifications, and it is possible to avoid a case where a low-accuracy process is selected and a result, which does not meet the user's request, is obtained.

Note that, in the example of FIG. 6, in a case where a plurality of cameras 2 are connected to the image processing device 1 and processing is performed on images of a space (for example, images of a certain store) captured by the plurality of cameras 2, the tracking process described above is a process for multi-camera object tracking. To be precise, this multi-camera object tracking is tracking a plurality of tracking target objects across (captured images of) a plurality of cameras while considering occlusion (which is hiding of the tracking target object from the camera).

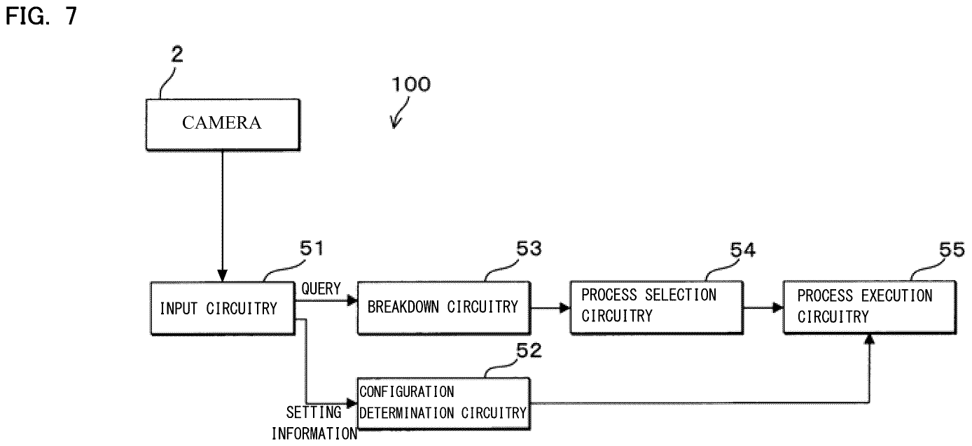

FIG. 7 shows functional blocks of the image processing system 100 according to the first embodiment. FIG. 7 is a diagram for explaining that each constituent element (each circuitry) in the claims is described in the first embodiment. The image processing system 100 comprises, as functional blocks, an input circuitry 51 configured to allow a user to input a query corresponding to desired image processing, a breakdown circuitry 53 configured to break a task included in the query input by the input circuitry 51 down into a plurality of known tasks, a process selection circuitry 54 configured to select respective processes corresponding to each of the plurality of known tasks broken down by the breakdown circuitry 53, and a process execution circuitry 55 configured to connect and perform the respective processes selected by the process selection circuitry 54. Further, the image processing system 100 comprises, as a functional block, a configuration determination circuitry 52 configured to determine a configuration, which is setting information to be referred to when the respective processes are performed, in accordance with at least one of an installation environment of the camera 2 that is an input source of a frame image to be used for the image processing and a size of an image processing object appearing in the frame image of the camera 2.

The input circuitry 51 is implemented mainly by the operation unit 44, the processing unit 40, and the communication unit 42 of the client 4, and the communication unit 32 and the processing unit 30 of the server 3. The processing performed by the input circuitry 51 is the processing of the steps S301 to S303 (mainly the processing of the step S303) in FIG. 5. The configuration determination circuitry 52 is implemented by the processing unit 30 of the server 3, and performs the processing of the step S307 in FIG. 5. The breakdown circuitry 53 is implemented by the processing unit 30 of the server 3 and performs the processing of the step S304 in FIG. 5. In the example illustrated in FIG. 6, as described above, the breakdown circuitry 53 breaks a task included in the input query down into a plurality of known tasks of “<detection target>person detection, <detection target tracking method>person ID assignment by person tracking, <attribute to be recognized>old age, wearing glasses, wearing a hat” by the analysis processing in the step S304. The process selection circuitry 54 is implemented by the processing unit 30 of the server 3, and performs the processing of the step S305 in FIG. 5. As shown in FIG. 6, the processes that can be selected by the process selection circuitry 54 include processes (a person detection process, a tracking process, an elderly person recognition process, a glasses wearing recognition process, and a hat wearing recognition process in FIG. 6) for respective frame images used for the image processing, and a process (a summarization process in FIG. 6) in which execution results of the processes for the respective frame images are collectively input into the language model for summarization to obtain a collective execution result of the plurality of frame images. These processes are modularized and can be freely connected to each other.

The query to be input by the input circuitry 51 may include information related to the specifications of a device (mainly, the image processing device 1) used to perform the image processing, and the breakdown circuitry 53 may not only break the task included in the input query down into a plurality of known tasks but also break information related to the specifications of the device included in the query down into a plurality of information (for example, information such as “perform by a high-performance device (image processing device 1)” or “perform by a device (image processing device 1) having a CPU with a processing capability of . . . ”). The specification information of the device extracted by the breakdown is used to determine the configuration by the configuration determination circuitry 52.

### Second Embodiment

In the second embodiment, the image processing system 100 employs the RAG so that plural tasks corresponding to a user's request and respective processes corresponding to each of the plural tasks can be more appropriately selected. The configuration of the image processing system 100 according to the second embodiment is the same as that of the image processing system 100 according to the first embodiment except for a processing procedure and data for adopting the RAG, which will be described later. Therefore, common components are denoted by the same reference numerals, and detailed description thereof will be omitted.

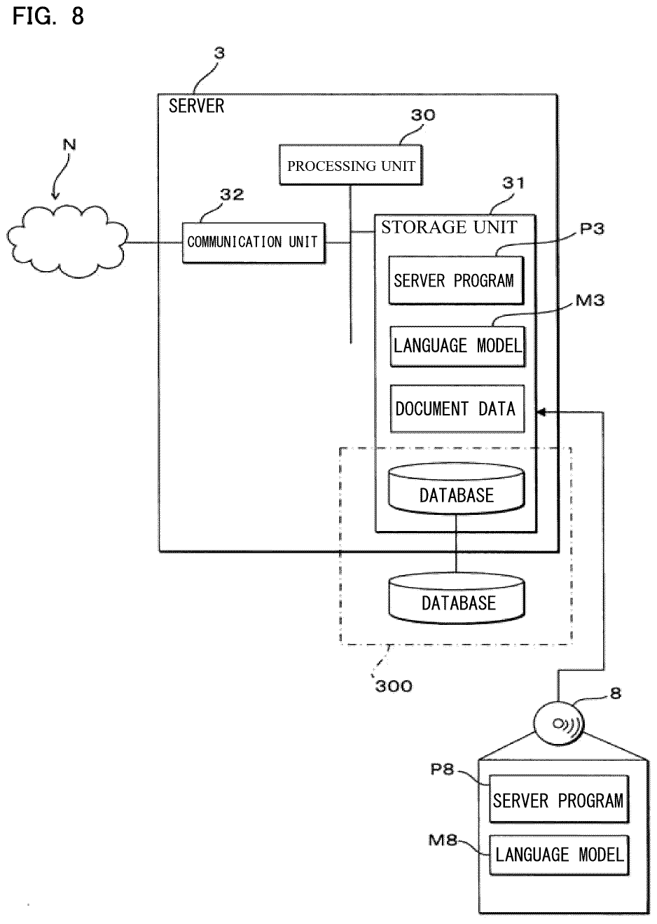

FIG. 8 is a block diagram illustrating a configuration of the server 3 in the second embodiment. In the second embodiment, the server 3 stores, in the database 300 or the storage unit 31, a document data group such as a manual defining a rule for breaking a task included in a request (query) input by a user down into a plurality of known tasks. Each piece of the document data may be created in advance by an operator, or may be obtained by storing, in a predetermined format, a record of a correspondence relationship between a request actually input by a user and a task that can output a result satisfying the user.

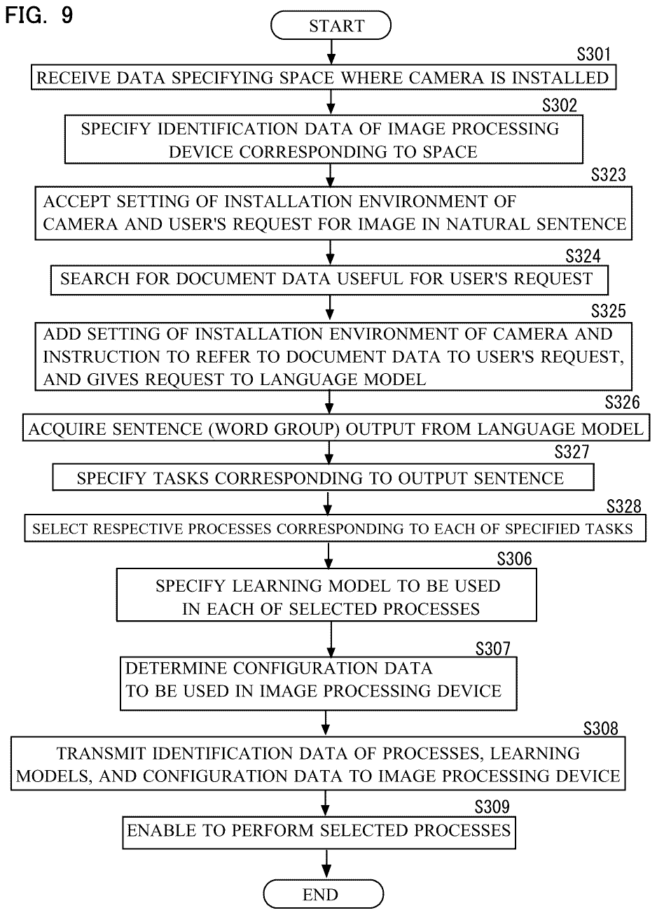

Processing in which the image processing system 100 according to the second embodiment selects processes with reference to the document data in response to the user's request, and enables the selected processes to be performed will be described. FIG. 9 is a flowchart illustrating an example of a process selection processing procedure in the image processing system 100 according to the second embodiment. When the user accesses the server 3 using the client 4 and accesses a Web page for setting the image processing device 1, the server 3 starts the following processing.

In the processing procedure illustrated in FIG. 9, the same step numbers are given to procedures common to the processing procedure illustrated in FIG. 5 of the first embodiment, and detailed description thereof will be omitted.

After the processing unit 30 of the server 3 receives the data specifying the target space (step S301) and specifies the identification data of the image processing device 1 (step S302), the processing unit 30 accepts the setting of the installation environment in which the camera 2, whose image are processed by the specified image processing device 1, is installed and the user's request for the image captured by the camera 2 on the web in the form of a natural sentence (step S323).

The processing unit 30 searches for document data useful for the accepted user's request (step S324). In the step S324, the processing unit 30 may extract document data which includes the word group included in the query corresponding to the user's request, or may extract appropriate document data from the document data group stored in the storage unit 31 using the language model M3.

The processing unit 30 adds both the accepted setting of the installation environment and an instruction to refer to the document data retrieved in the step S324 to the accepted user's request, and gives the request to the language model M3 (step S325). In the step S325, the processing unit 30 combines a natural sentence corresponding to the user's request with an instruction sentence to output according to a rule defined by the document data with reference to the setting of the installation environment and the document data, and inputs the combined sentence to the language model M3. The rules defined in the document data will be described in detail later.

The processing unit 30 acquires a sentence (word group) output from the language model M3 (step S326). The processing unit 30 specifies a tasks corresponding to the sentence output from the language model M3 (step S327). The language model M3 referring to the document data breaks the user's request (query) down into names or identification data of known tasks such as “person detection”, “gender recognition”, “elderly person recognition”, “glasses wearing recognition”, and “hat wearing recognition” defined in advance. In the step S327, the processing unit 30 may break the task included in the query down into at least an object detection task and an object recognition task. In the step S327, the processing unit 30 acquires a word group indicating tasks output from the language model M3 referring to the document data. In the step S327, the processing unit 30 may specify the tasks with reference to the setting of the installation environment of the camera 2. For example, the processing unit 30 selects the SLM as the language model for the image processing device 1 having a small amount of computational resources, or specifies a task to which a process of reducing the influence of ambient light is added in a case of the camera 2 installed outdoors.

The processing unit 30 selects respective processes corresponding to each of the tasks specified in the step S327 (step S328). In the step S328, respective processes are associated with respective preset tasks, and the processing unit 30 selects respective processes corresponding to each of the tasks from the association. For example, the “person detection process” is defined (set) for the task of “person detection.”

The processing unit 30 specifies a learning model to be used in each of the selected processes from among the learning models stored in the database 300 (step S306). The processing unit 30 specifies that the LLM is used, for example, in a case where the processing speed and the memory of the image processing device 1 are equal to or higher than a predetermined specification level from the data of the computational resources included in the specification of the image processing device 1, and specifies that the SLM is used in the opposite case.

Thereafter, as in the first embodiment, the processing unit 30 determines configuration data (step S307), transmits identification data of the selected processes, the specified learning model, and the determined configuration data to the image processing device 1 (step S308), and performs the process of step S309.

Also in the second embodiment, the processing procedure illustrated in FIG. 9 has been described as being performed by the server 3. Alternatively, the image processing device 1 may receive an operation from the client 4 via the network N and perform the processing procedure illustrated in FIG. 9, or the image processing device 1 may directly receive an operation from the client 4 via the second communication unit 13 and perform the processing procedure illustrated in FIG. 9 using the language model M3 provided from the server 3.

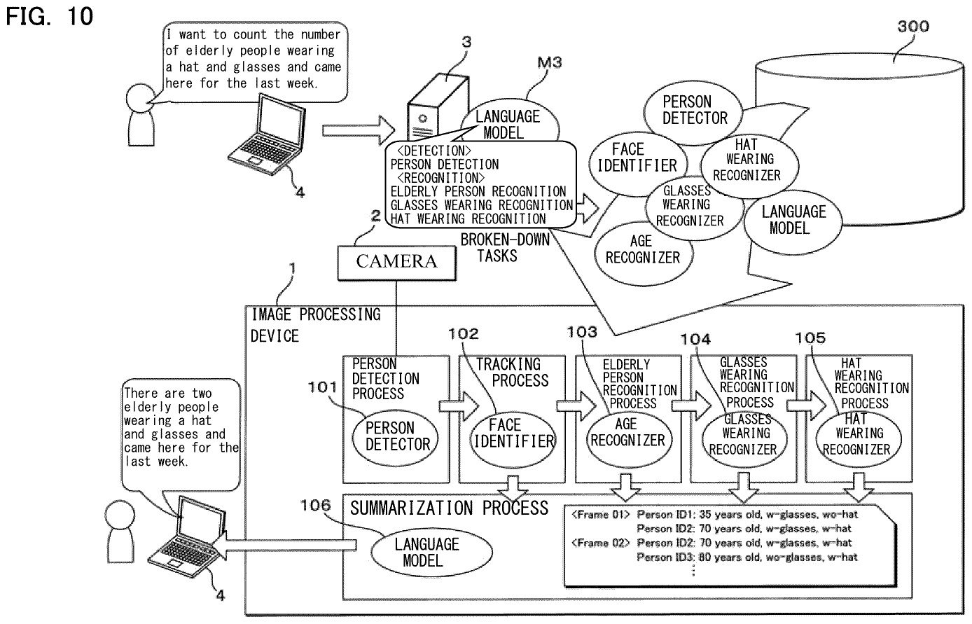

The processing procedure shown in FIG. 9 will be described with a specific example. FIG. 10 is a diagram illustrating an example of processing in which respective processes are selected in the image processing device 1 according to the second embodiment. FIG. 10 illustrates processing from when respective processes are selected in response to the user's request to when the selected processes are performed by the image processing device 1, similarly to FIG. 6 of the first embodiment. Similarly to the first embodiment, FIG. 10 also illustrates a processing in a case where the user designates data for identifying a space, in which the target camera 2 is installed, and inputs a natural sentence “I want to count the number of elderly people who wore a hat and glasses and came to this place for the last week.” in the client 4.

In the second embodiment, the processing unit 30 searches for document data which corresponds to the above-described natural sentence accepted as a user's request and includes keywords such as “hat”, “glasses”, and “old age.” The processing unit 30 combines a natural sentence corresponding to the user's request (query) with an instruction sentence such as “Please break the attached query down into tasks with reference to the designated document data.” and gives the combined sentence to the language model M3.

The query input by the user is broken down into tasks such as “person detection/elderly person recognition/glasses wearing recognition/hat wearing recognition” by the language model M3 referring to the document data defining the breakdown rule. It is desirable that the processing unit 30 breaks the tasks included in the query down into at least an object detection task and an object recognition task. The processing unit 30 can directly select processes corresponding to the broken-down tasks, for example, a person detection process, an elderly person recognition process, a glasses wearing recognition process, and a hat wearing recognition process.

The processing unit 30 sets the broken-down tasks such as “person detection/elderly person recognition/glasses wearing recognition/hat wearing recognition” described above as tasks for each frame by the language model M3 referring to the document data, and also breaks the task included in the query down into a summarization task for aggregating detection results and recognition results over a plurality of frame images from the word “for the last week.”

As illustrated in FIG. 10, since the processing unit 30 can break the task included in the query down into tasks, for each of which a process can be easily selected, by using the language model M3, an appropriate process can be selected.

It is preferable that the document data includes specification information regarding the computing resources of the image processing device 1 to be used. Thus, the processing unit 30 can refer to the specification information associated with the identification data of the image processing device 1 and specify tasks, learning models, and processes to be selected according to the referred specification information. When the specifications of the image processing device 1 are at a low level (computational resources are relatively poor), the processing unit 30 can select a process or a learning model that performs processing as light as possible. As described above, the processing unit 30 breaks the input user's request down into necessary tasks with reference to the rules defined in the document data, thereby selecting appropriate processes and connecting the selected processes to perform image processing.

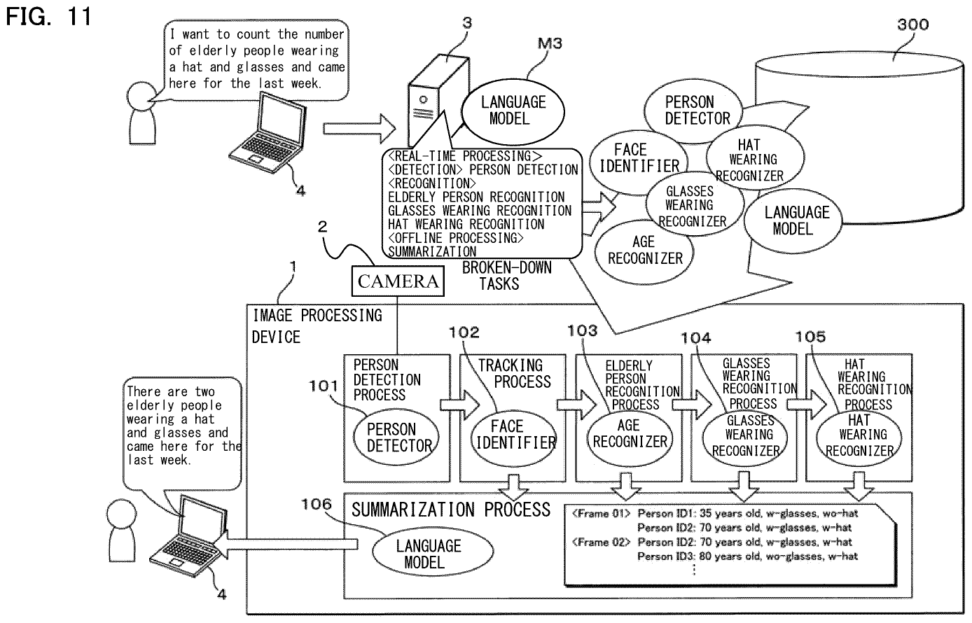

FIG. 11 is a diagram illustrating another example of a processing in which processes are selected in the image processing device 1 according to the second embodiment. Similarly to FIG. 10, FIG. 11 illustrates a result of breaking the input user's request (query) down into tasks using the language model M3. Also in FIG. 11, the input user's request indicates a processing in a case where a natural sentence “I want to count the number of elderly people who wore a hat and glasses and came to this place for the last week.” is input.

In the example of FIG. 11, similarly to FIG. 10, the processing unit 30 sets the broken-down tasks such as “person detection/elderly person recognition/glasses wearing recognition/hat wearing recognition” described above as tasks for each frame image by the language model M3 referring to the document data, and also breaks the task included in the query down into a summarization task for aggregating detection results and recognition results over a plurality of frame images from the word “for the last week.” However, in the example of FIG. 11, the processing unit 30 selects respective processes corresponding to each of the tasks, after clearly breaking the tasks down into a task to be sequentially performed in real time or a task to be performed in a given period of time afterward, such as “<real-time processing target>person detection/elderly person recognition/glasses wearing recognition/hat wearing recognition, <offline processing target>summarization.” This processing corresponds to the processing that (the breakdown circuitry) “breaks the task included in the query input by the input circuitry down into at least a real-time processing task and an offline processing task” in the claims.

Appropriate tasks (processes) for a real-time processing are different from appropriate tasks (processes) for an offline processing. Accordingly, by breaking the task included in the query down into real-time processing tasks and an offline processing task as described above, the image processing system 100 can select respective processes corresponding to each of broken-down tasks with high accuracy and connect and perform the selected processes. At this time, the tasks on the real-time processing side (tasks such as “person detection/elderly person recognition/glasses wearing recognition/hat wearing recognition” described above) may be performed by the image processing device 1 (“an edge device” in the claims), and the tasks on the offline processing side (“summarization” task) may be performed by the server 3 (“a cloud server” in the claims). For example, on the real-time processing side, the image processing device 1 (the edge device) may convert a frame image into text information by using VLM (output text information that is a processing result of each task on the real-time processing side), and the server 3 (cloud server) may perform a process (for example, the above-described “summarization process”) such as extracting information by applying LLM to the text information.

Also in the second embodiment, the image processing system 100 automatically selects processes according to the user's request only by the user inputting a request for what to do using an image captured by the target camera 2 to the image processing system 100 in a natural language, for example, on a web page or the like. Therefore, it is not necessary for the user to select a learning model prepared according to various specifications (of the image processing device 1 or the like) for data of various fields.

The breakdown circuitry 53 (see FIG. 7) in the second embodiment comprises a search function to search for a document (the above-described “document data”), which is useful for breaking the task included in the query down into the plurality of known tasks, and the language model M3 for task breakdown. The breakdown circuitry 53 inputs the document (document data) searched by the search function along with the query into the language model M3 for task breakdown to break the task included in the query down into the plurality of known tasks. This processing corresponds to the steps S324 to S327 in FIG. 9.

### Third Embodiment

In the second embodiment, the processing unit 30 gives the input query to the language model M3, and employs the RAG that makes the language model M3 refer to the document data to break the query down into appropriate tasks. In the third embodiment, when the server 3 determines that the task included in the query cannot be broken down into appropriate tasks, because the query does not include all the necessary information, the server 3 prompts the user to additionally input necessary information.

The configuration of the image processing system 100 according to the third embodiment is the same as that of the image processing system 100 according to the first embodiment or the second embodiment except that the processing procedure described below is different from that of the first embodiment or the second embodiment. Therefore, common components are denoted by the same reference numerals, and detailed description thereof will be omitted.

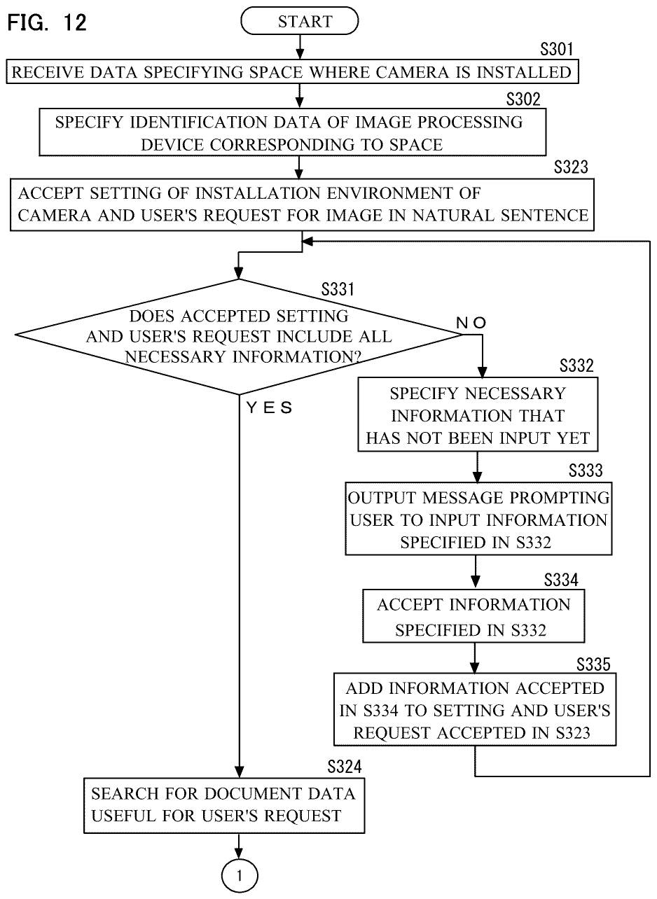

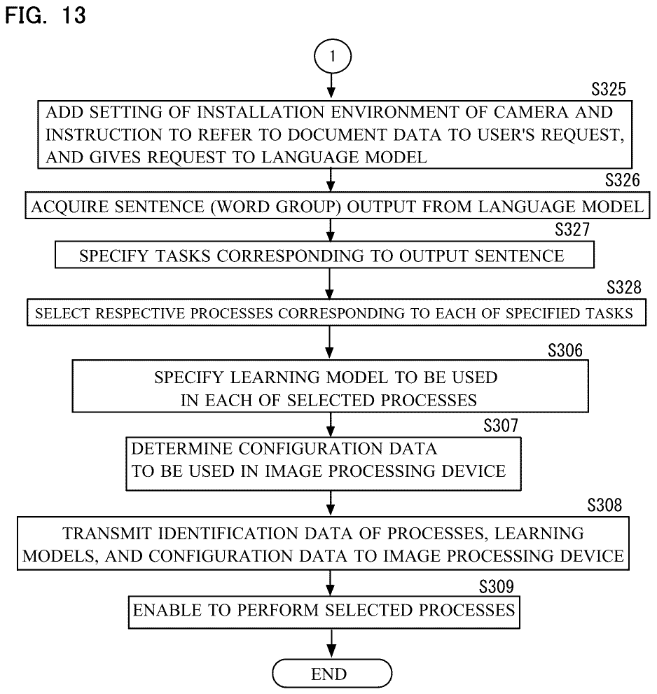

FIGS. 12 and 13 are flowcharts illustrating an example of a process selection processing procedure in the image processing system 100 according to the third embodiment. When the user accesses the server 3 using the client 4 and accesses a Web page for setting the image processing device 1, the server 3 starts the following processing. In the processing procedure illustrated in FIGS. 12 and 13, the same step numbers are given to procedures common to the processing procedure illustrated in FIG. 5 of the first embodiment and FIG. 9 of the second embodiment, and detailed description thereof will be omitted.

After the processing unit 30 of the server 3 receives the data specifying the target space (step S301) and specifies the identification data of the image processing device 1 (step S302), the processing unit 30 accepts the setting of the installation environment in which the camera 2, whose image are processed by the specified image processing device 1, is installed and the user's request for the image captured by the camera 2 on the web in the form of a natural sentence (step S323).

The processing unit 30 determines whether the setting of the installation environment and the user's request accepted in the step S323 include all necessary information (step S331). In the step S331, for example, the processing unit 30 acquires a response sentence by inputting the setting and the request received in the step S323 and a sentence asking whether or not the tasks included in the request (query) can be broken down or whether or not all necessary information can be acquired by the accepted setting and request to the language model M3. When the response sentence is “true,” the processing unit 30 determines that the setting of the installation environment and the user's request includes all necessary information. To the contrary, when the response sentence is “false,” the processing unit 30 determines that the setting of the installation environment and the user's request do not include all necessary information. In the step S331, the processing unit 30 may determine whether or not the setting and the request accepted in the step S323 include all necessary information by comparing the accepted setting and request with the template without using the language model M3.

When the processing unit 30 determines in the step S331 that the accepted setting and request include all necessary information (S331: YES), the processing unit 30 searches for document data useful for the user's request accepted in the step S323 (step S324). The processing unit 30 performs the processes of S325 to S328 and S306 to S309.

When the processing unit 30 determines in the step S331 that the accepted setting and request do not include all necessary information (S331: NO), the processing unit 30 specifies necessary information that has not been input yet (step S332). Then the processing unit 30 makes the client 4 notify the user of a message prompting the user to input the information specified in the step S332 (step S333). In the step S333, the processing unit 30 may notify the user using a fixed phrase for each piece of lacking information. The processing unit 30 may notify the user using the response sentence obtained from the language model M3 in the step S333. The processing unit 30 may cause the language model M3 to create a message prompting the user to input lacking information by providing the language model M3 with an instruction sentence that instructs the language model M3 to create the above-described message. The processing unit 30 accepts the information specified in the step S332 (necessary information that has not been input yet) with a user input from the web page displayed on the client 4 (step S334).

The processing unit 30 adds the information accepted in the step S334 to the setting and the user's request accepted in the step S323 (step S335), and returns to the processing of the step S331.

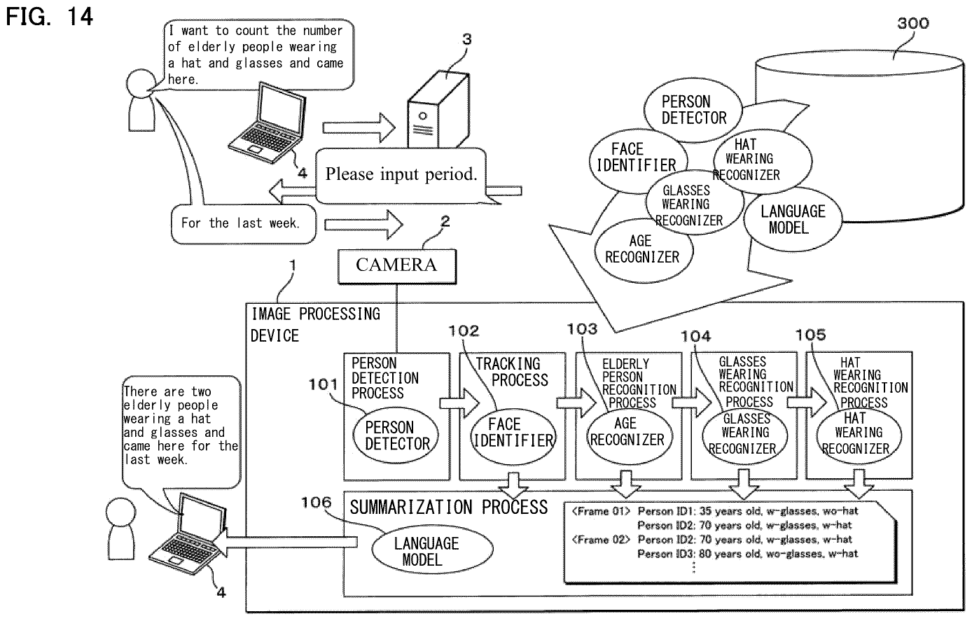

The processing procedure shown in FIGS. 12 and 13 will be described with a specific example. FIG. 14 is a diagram illustrating an example of processing in which respective processes are selected in the image processing device 1 according to the third embodiment. FIG. 14 illustrates processing from when respective processes are selected in response to the user's request to when the selected processes are performed by the image processing device 1, similarly to FIG. 6 of the first embodiment, and FIGS. 10 and 11 of the second embodiment.

The example of FIG. 14 illustrates a processing in a case where the user designates data for identifying a space, in which the target camera 2 is installed, and inputs a natural sentence “I want to count the number of elderly people who wore a hat and glasses and came to this place.” in the client 4. In the third embodiment, the processing unit 30 determines that the above-described natural sentence accepted as a user's request do not include all necessary information (S331: NO), and identifies “period” as necessary information that has not been input yet (step S332). Then the processing unit 30 creates a message such as “Please input period.” and makes the client 4 notify the user of the message (step S333).

Also in the third embodiment, the image processing system 100 automatically selects processes according to the user's request only by the user inputting a request for what to do using an image captured by the target camera 2 to the image processing system 100 in a natural language, for example, on a web page or the like. Therefore, it is not necessary for the user to select a learning model prepared according to various specifications (of the image processing device 1 or the like) for data of various fields.

Through the notification from the server 3, the user can know the deficiency of the information necessary for realizing the user's request in the image processing device 1. The user can obtain an output reflecting the user's request from the image processing device 1 by responding to an inquiry about necessary information in advance rather than acquiring a result with low accuracy using an incomplete query.

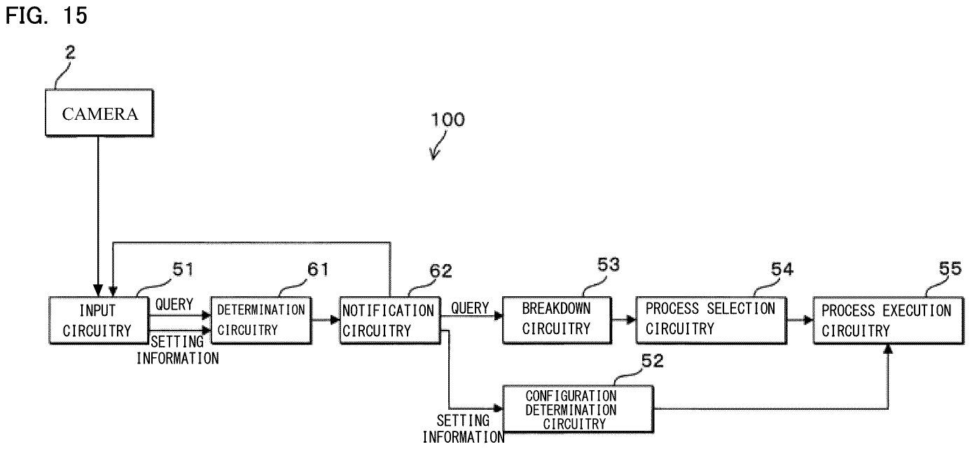

FIG. 15 shows functional blocks of the image processing system 100 according to the third embodiment. The image processing system 100 according to the third embodiment comprises, as functional blocks, a determination circuitry 61 configured to determine whether the query input by the input circuitry 51 includes all the necessary information, and a notification circuitry 62 configured to output information for prompting the user to input, by the input circuitry 51, information that has not been input yet among all the necessary information when the determination circuitry 61 determines that the query does not include all the necessary information, in addition to the functional blocks illustrated in FIG. 7.

The determination circuitry 61 is implemented by the processing unit 30 of the server 3, and performs the processing of the step S331 in FIG. 12. The notification circuitry 62 is mainly implemented by the processing unit 30 of the server 3 and the processing unit 40 and the display unit 43 of the client 4, and mainly performs the processing of the step S333 in FIG. 12.

These and other modifications will become obvious, evident or apparent to those ordinarily skilled in the art, who have read the description. Accordingly, the appended claims should be interpreted to cover all modifications and variations which fall within the spirit and scope of the present invention.

1. An image processing system comprising:
a process selection circuitry configured to select respective processes corresponding to each of plural tasks that constitute image processing requested by a user; and
a process execution circuitry configured to connect and perform the respective processes selected by the process selection circuitry.

2. The image processing system according to claim 1, further comprising a configuration determination circuitry configured to determine a configuration, which is setting information to be referred to when the respective processes are performed, in accordance with at least one of an installation environment of a camera that is an input source of an image to be used for the image processing and a size of an image processing object appearing in an image of the camera,
wherein the process execution circuitry performs the respective processes with reference to the configuration determined by the configuration determination circuitry.

3. The image processing system according to claim 1,
wherein the respective processes, which can be selected by the process selection circuitry, include a process corresponding to an object detection task and a process corresponding to an object recognition task, and
a detector used for the process corresponding to the object detection task and a recognizer used for the process corresponding to the object recognition task are modularized and can be connected to each other.

4. The image processing system according to claim 1,
wherein the process execution circuitry collectively inputs execution results for a plurality of frame images used for the image processing into a language model for summarization to obtain a collective execution result for the plurality of frame images.

5. The image processing system according to claim 1,
wherein the respective processes, which can be selected by the process selection circuitry, include a process for respective frame images used for the image processing, and a process for collectively inputting execution results of the process for the respective frame images into a language model for summarization to obtain a collective execution result for the respective frame images, and
the respective processes are modularized and can be connected to each other.

6. An image processing system comprising:
an input circuitry configured to allow a user to input a query corresponding to desired image processing; and
a breakdown circuitry configured to break a task included in the query input by the input circuitry down into a plurality of known tasks.

7. The image processing system according to claim 6,
wherein the breakdown circuitry comprises a search function to search for a document, which is useful for breaking the task included in the query down into the plurality of known tasks, and a language model for task breakdown, and
the breakdown circuitry inputs the document searched by the search function into the language model for task breakdown along with the query input by the input circuitry to break the task included in the query down into the plurality of known tasks.

8. The image processing system according to claim 6,
wherein the breakdown circuitry breaks the task included in the query input by the input circuitry down into at least an object detection task and an object recognition task.

9. The image processing system according to claim 6,
wherein the breakdown circuitry breaks the query input by the input circuitry down into at least specification information of a device used for the image processing.

10. The image processing system according to claim 6,
wherein the breakdown circuitry breaks the task included in the query input by the input circuitry down into at least a task corresponding to a process for each frame image and a task corresponding to a process for a plurality of frame images.

11. The image processing system according to claim 6,
wherein the breakdown circuitry breaks the task included in the query input by the input circuitry down into at least a real-time processing task and an offline processing task.

12. The image processing system according to claim 11,
wherein the image processing system comprises an edge device and a cloud server,
the edge device performs the real-time processing task, and
the cloud server performs the offline processing task.

13. The image processing system according to claim 6, further comprising: a determination circuitry configured to determine whether the query input by the input circuitry includes all the necessary information; and
a notification circuitry configured to output information for prompting the user to input, by the input circuitry, information that has not been input yet among all the necessary information when the determination circuitry determines that the query does not include all the necessary information.

14. An image processing system comprising:
an input circuitry configured to allow a user to input a query corresponding to desired image processing;
a breakdown circuitry configured to break a task included in the query input by the input circuitry down into a plurality of known tasks;
a process selection circuitry configured to select respective processes corresponding to each of the plurality of known tasks broken down by the breakdown circuitry; and
a process execution circuitry configured to connect and perform the respective processes selected by the process selection circuitry.

15. The image processing system according to claim 14,
wherein the breakdown circuitry extracts, from the query input by the input circuitry, information of a detection target obtained by an object detection task included in the query and information of a recognition target obtained by an object recognition task included in the query.

16. A non-transitory computer-readable recording medium for recording an image processing program to cause a computer to perform a process including the steps of:
selecting respective processes corresponding to each of plural tasks that constitute image processing requested by a user; and
connecting and performing the respective processes.
